(19) United States
(12) Patent Application Publication
(10) Pub. No.: US 2026/0312437 A1
(43) Pub. Date: Oct. 8, 2026

(54) ENABLING USER EQUIPMENT (UE) POSITIONING AND REDUCING ELECTRONIC LABEL POWER CONSUMPTION USING BATTERY-LESS ENERGY HARVESTING TAG (ETAG) DEPLOYMENTS

(71) Applicant: QUALCOMM Incorporated, San Diego, CA (US)

(72) Inventors: Varun Amar REDDY, San Diego, CA (US); Sony AKKARAKARAN, Poway, CA (US); Amit GOEL, San Diego, CA (US)

(21) Appl. No.: 19/575,037

(22) Filed: Mar. 23, 2026

Related U.S. Application Data
(60) Provisional application No. 63/783,462, filed on Apr. 4, 2025.

(51) Int. Cl. H02J 50/80; H02J 50/00

(52) U.S. Cl. CPC H02J 50/80; H02J 50/001; H02J 50/005

(57) ABSTRACT

In some aspects, a method of positioning performed by an energy harvesting tag (eTag) includes receiving an energizing waveform including control information, wherein the control information indicates a configuration for beacon signal transmission by the eTag, wherein the configuration indicates a spatial interleaving factor, a time slot offset, and a channel; and transmitting, during a subsequent subframe, a beacon signal according to the configuration.

### CROSS-REFERENCE TO RELATED APPLICATIONS

The present Application for Patent claims the benefit of U.S. Provisional Application No. 63/783,462, entitled “ENABLING USER EQUIPMENT (UE) POSITIONING AND REDUCING ELECTRONIC LABEL POWER CONSUMPTION USING BATTERY-LESS ENERGY HARVESTING TAG (ETAG) DEPLOYMENTS,” filed Apr. 4, 2025, assigned to the assignee hereof, and expressly incorporated herein by reference in its entirety.

### BACKGROUND OF THE DISCLOSURE

### 1. Field of the Disclosure

Aspects of the disclosure relate generally to wireless technologies.

### 2. Description of the Related Art

Electronic shelf labels (ESLs) are used by retailers for displaying product pricing or other product information to consumers. ESLs typically use electronic paper (e-paper) or liquid crystal display (LCD) to display the current information. E-paper (also referred to as e-ink) is widely used for ESLs, as it provides a sharp display and supports full graphic imaging while only needing power during updates and no power to retain an image.

ESLs are increasingly being integrated with existing retail technologies, such as electronic article surveillance, digital signage, and people counters. For example, retailers can upload a floor plan of the sales area into the ESL management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of positioning performed by an energy harvesting tag (eTag) includes receiving an energizing waveform including control information, wherein the control information indicates a configuration for beacon signal transmission by the eTag, wherein the configuration indicates a spatial interleaving factor, a time slot offset, and a channel; and transmitting, during a subsequent subframe, a beacon signal according to the configuration.

In an aspect, a method of communication performed by an energy harvesting tag (eTag) includes receiving an energizing waveform including control information, wherein the control information indicates a visual indication to be displayed by an electronic label display to which the eTag is communicatively coupled; and transmitting the control information to the electronic label display.

In an aspect, a method of communication performed by a server includes receiving, from a user equipment (UE), an energy harvesting tag (eTag) identifier of an eTag located in an indoor environment, a signal strength measurement of a beacon signal transmitted by the eTag, and a timestamp associated with the signal strength measurement; and updating a user behavior database for the indoor environment based on the eTag identifier, the signal strength measurement, and the timestamp.

In an aspect, an energy harvesting tag (eTag) includes one or more memories; one or more antennas; and one or more processors communicatively coupled to the one or more memories and the one or more antennas, the one or more processors, either alone or in combination, configured to: receive, via the one or more antennas, an energizing waveform including control information, wherein the control information indicates a configuration for beacon signal transmission by the eTag, wherein the configuration indicates a spatial interleaving factor, a time slot offset, and a channel; and transmit, via the one or more antennas, during a subsequent subframe, a beacon signal according to the configuration.

In an aspect, an energy harvesting tag (eTag) includes one or more memories; one or more antennas; and one or more processors communicatively coupled to the one or more memories and the one or more antennas, the one or more processors, either alone or in combination, configured to: receive, via the one or more antennas, an energizing waveform including control information, wherein the control information indicates a visual indication to be displayed by an electronic label display to which the eTag is communicatively coupled; and transmit, via the one or more antennas, the control information to the electronic label display.

In an aspect, a server includes one or more memories; one or more transceivers; and one or more processors communicatively coupled to the one or more memories and the one or more transceivers, the one or more processors, either alone or in combination, configured to: receive, via the one or more transceivers, from a user equipment (UE), an energy harvesting tag (eTag) identifier of an eTag located in an indoor environment, a signal strength measurement of a beacon signal transmitted by the eTag, and a timestamp associated with the signal strength measurement; and update a user behavior database for the indoor environment based on the eTag identifier, the signal strength measurement, and the timestamp.

In an aspect, an energy harvesting tag (eTag) includes means for receiving an energizing waveform including control information, wherein the control information indicates a configuration for beacon signal transmission by the eTag, wherein the configuration indicates a spatial interleaving factor, a time slot offset, and a channel; and means for transmitting, during a subsequent subframe, a beacon signal according to the configuration.

In an aspect, an energy harvesting tag (eTag) includes means for receiving an energizing waveform including control information, wherein the control information indicates a visual indication to be displayed by an electronic label display to which the eTag is communicatively coupled; and means for transmitting the control information to the electronic label display.

In an aspect, a server includes means for receiving, from a user equipment (UE), an energy harvesting tag (eTag) identifier of an eTag located in an indoor environment, a signal strength measurement of a beacon signal transmitted by the eTag, and a timestamp associated with the signal strength measurement; and means for updating a user behavior database for the indoor environment based on the eTag identifier, the signal strength measurement, and the timestamp.

In an aspect, a non-transitory computer-readable medium stores computer-executable instructions that, when executed by an energy harvesting tag (eTag), cause the eTag to: receive an energizing waveform including control information, wherein the control information indicates a configuration for beacon signal transmission by the eTag, wherein the configuration indicates a spatial interleaving factor, a time slot offset, and a channel; and transmit, during a subsequent subframe, a beacon signal according to the configuration.

In an aspect, a non-transitory computer-readable medium stores computer-executable instructions that, when executed by an energy harvesting tag (eTag), cause the eTag to: receive an energizing waveform including control information, wherein the control information indicates a visual indication to be displayed by an electronic label display to which the eTag is communicatively coupled; and transmit the control information to the electronic label display.

In an aspect, a non-transitory computer-readable medium stores computer-executable instructions that, when executed by a server, cause the server to: receive, from a user equipment (UE), an energy harvesting tag (eTag) identifier of an eTag located in an indoor environment, a signal strength measurement of a beacon signal transmitted by the eTag, and a timestamp associated with the signal strength measurement; and update a user behavior database for the indoor environment based on the eTag identifier, the signal strength measurement, and the timestamp.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example electronic shelf label (ESL) system, according to aspects of the disclosure.

FIG. 2 illustrates example components of an example ESL, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example ESL deployment scenario, according to aspects of the disclosure.

FIG. 5 is a diagram illustrating an example positioning scenario using a weighted centroid algorithm, according to aspects of the disclosure.

FIG. 6 illustrates an example electronic tag, according to aspects of the disclosure.

FIG. 7 illustrates an example BLUETOOTH® Low Energy (BLE) generic attribute profile (GATT) procedure, according to aspects of the disclosure.

FIG. 8 illustrates an example ESL periodic advertising with responses (PAWR) scheme, according to aspects of the disclosure.

FIG. 9 is a diagram illustrating an example scenario of positioning a UE using energy harvesting tags (eTags) as anchor nodes, according to aspects of the disclosure.

FIG. 10 illustrates an example method of positioning, according to aspects of the disclosure.

FIG. 11 illustrates an example method of communication, according to aspects of the disclosure.

FIG. 12 illustrates an example method of communication, according to aspects of the disclosure.

FIG. 13 illustrates an example method of communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to energy harvesting tag (eTag) deployments. Some aspects more specifically relate to enabling user equipment (UE) positioning and reducing electronic shelf label (ESL) power consumption using eTag deployments. In some examples, techniques are provided for scheduling eTag beacon transmissions to minimize interference, using eTag beacons to signal/configure visual indications on ESL displays, mitigating interference between eTags and ESL radios, and inferring user statistics and behavior for targeted advertising.

Particular aspects of the subject matter described in this disclosure can be implemented to realize one or more of the following potential advantages. In some examples, by scheduling eTag beacon transmissions, the described techniques can be used to minimize interference among eTags and ESL radios.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IOT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

Electronic label displays (or electronic display devices), such as electronic shelf labels (ESLs), are used by retailers for displaying product pricing or other product information to consumers. ESLs typically use electronic paper (e-paper) or liquid crystal display (LCD) to display the current information. E-paper (also referred to as e-ink) is widely used for ESLs, as it provides a sharp display and supports full graphic imaging while only needing power during updates and no power to retain an image, thereby significantly reducing power consumption.

ESLs are increasingly being integrated with existing retail technologies, such as electronic article surveillance, digital signage, and people counters. For example, retailers can upload a floor plan of the sales area into the ESL management software. Consumers can then be tracked (in real time) through a network of people-counting devices, or via their personal BLUETOOTH® devices, in order to determine their position within the store at all times. This allows an individual customer to receive targeted, customized marketing initiatives, such as discounts, individual pricing, etc.

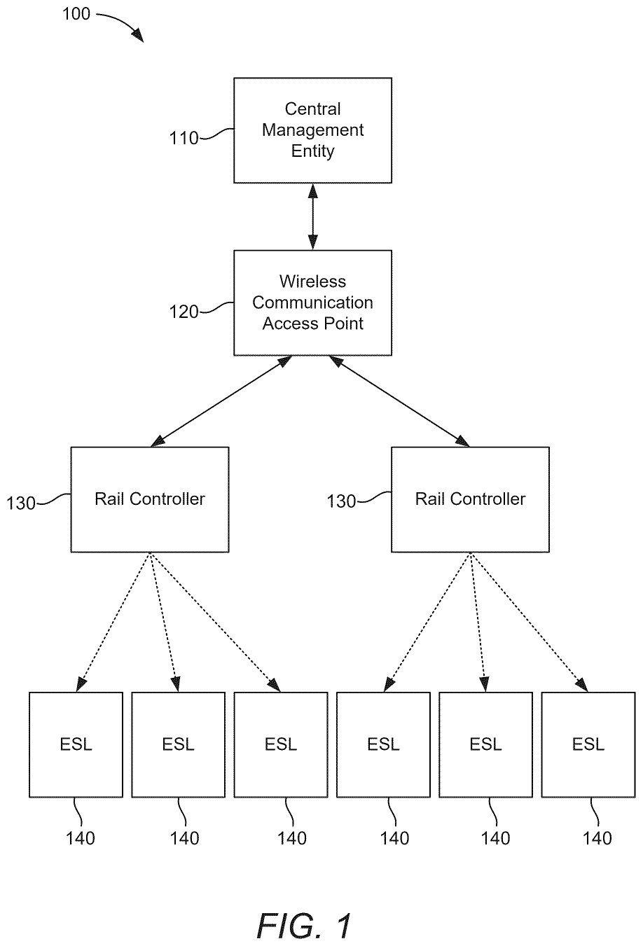

FIG. 1 illustrates an example ESL system 100, according to aspects of the disclosure. An ESL system generally includes three components: label management software (e.g., running on a central management entity 110, such as a local server at the retail location or a cloud-based server), one or more wireless communication access points 120 (e.g., Wi-Fi® access points), one or more rail controllers 130, and one or more (usually many) ESLs 140. The label management software is responsible for the configuration of the system, configuration of the properties of the ESLs 140 themselves, and storing the database of information to be displayed by the ESLs 140. The software mainly covers the network management, file systems, and transmission of data. It also processes and packs the data to be displayed into packets of information. The data packets are then sent to one or more wireless communication access points 120 via a wireless network (e.g., Wi-Fi®) for distribution to the ESLs 140 via the one or more rail controllers 130.

A wireless communication access point 120 is responsible for the stability and reliability of transmissions from the label management software (on the central management entity 110) to the ESLs 140. There may be multiple wireless communication access points 120 deployed in a single retail location based on the size of the space and/or the number of ESLs 140 deployed.

A wireless communication access point 120 communicates with one or more rail controllers 130 via a short-range wireless communications protocol, such as BLUETOOTH® Low Energy (BLE). A rail controller 130 may therefore include a BLE radio (or other short-range wireless communications protocol radio). A rail controller 130 may be powered by a battery (e.g., a lithium-ion battery) or a wired connection. A rail controller 130 is coupled to, or integrated into, a rail to which multiple ESLs 140 can be “clipped” or otherwise attached. Once clipped to the rail, each ESL 140 has a wired connection to the rail controller 130 (e.g., via a three-wire bus for power, ground, and data).

An ESL 140 functions as a receiver from the wireless communication access point 120 (via the rail controller 130) to display the information configured from the label management software. The ESL 140 then acts based on the instructions that were provided in the data packets from the label management software. An ESL 140 includes a display and optionally a camera. ESLs 140 generally do not include batteries, as they are typically powered by the rail to which they are attached. However, in some cases, an ESL 140 may be powered by a coin-cell battery, which may provide an operational life of eight to nine years. In some cases, an ESL 140 may not have a short-range wireless communications radio (e.g., a BLE radio), as it receives data from the wireless communication access point 120 via the wired rail connection to the rail controller 130.

An ESL application programming interface (API) is included in the current BLUETOOTH® specification and permits a 7-bit group identifier of 8-bit unique ESL identifiers, allowing for a total of 32,640 ESLs 140 to be allocated for one wireless communication access point 120. With those constraints, multiple wireless communication access points 120 may be needed to cover a typical grocery store ESL application.

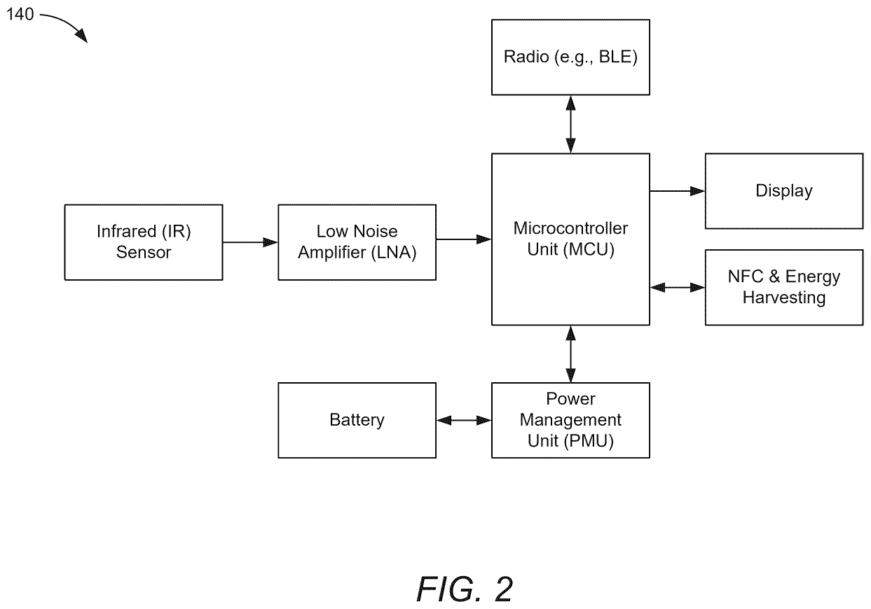

FIG. 2 illustrates example components of an example ESL 140, according to aspects of the disclosure. Note that in some cases, rather than an ESL 140 having its own wireless radio (e.g., a BLE radio) as shown in FIG. 2, multiple ESLs 140 may be attached (e.g., clipped) to a rail attached to a retail shelf. In this case, the rail (specifically a rail controller 130) contains the short-range wireless communications radio and the ESLs 140 have just the display. The rail controller 130 in the rail communicates locally to the clipped-on ESLs 140 over a wired protocol (the act of clipping on connects the ESLs 140 to the wires of the rail controller 130). As such, an ESL 140 itself may not have a radio but may connect locally to one (i.e., the rail controller 130). Note that in either case, the radio may also be referred to as a transceiver.

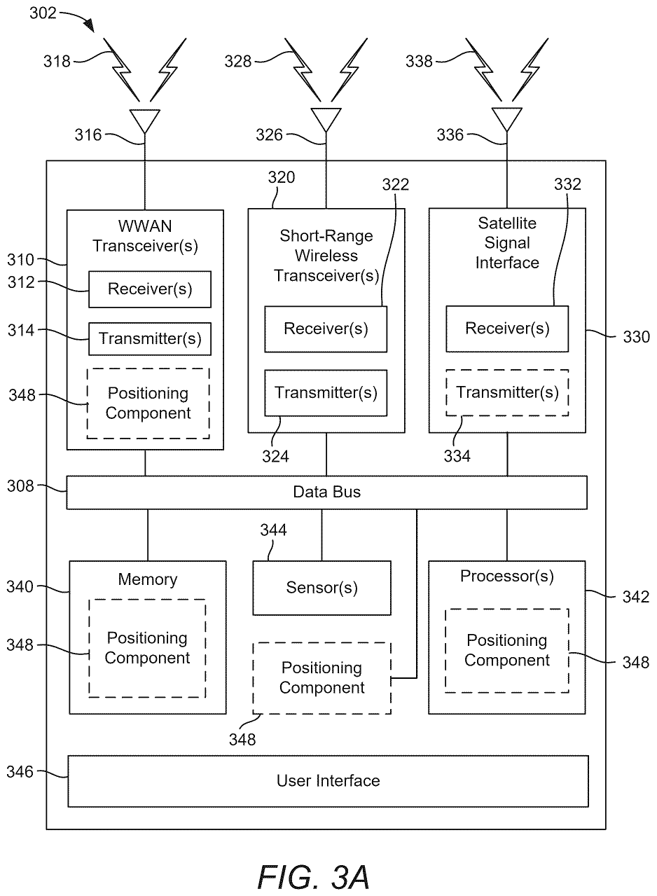

FIGS. 3A, 3B, and 3C illustrate several example components (represented by corresponding blocks) that may be incorporated into a UE 302 (which may correspond to any of the UEs described herein), a base station 304 (which may correspond to any of the base stations or access points described herein), and a network entity 306 (which may correspond to or embody any of the network functions described herein, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi®, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi® transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning components 348, 388, and 398, respectively. The positioning components 348, 388, and 398 may be hardware circuits that are part of or coupled to the processors 342, 384, and 394, respectively, and are configured to cause the UE 302, the base station 304, and the network entity 306 to perform the functionality described herein. In other aspects, the positioning components 348, 388, and 398 may be external to the processors 342, 384, and 394 (e.g., part of a modem processing system, integrated with another processing system, etc.). Alternatively, the positioning component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component 348, which may be, for example, part of the one or more WWAN transceivers 310, the memory 340, the one or more processors 342, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol date units (PDUs), error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi® and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi® “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component 348, 388, and 398, etc.

In some designs, the network entity 306 may be implemented as a core network component. In other designs, the network entity 306 may be distinct from a network operator or operation of the cellular network infrastructure. For example, the network entity 306 may be a component of a private network that may be configured to communicate with the UE 302 via the base station 304 or independently from the base station 304 (e.g., over a non-cellular communication link, such as Wi-Fi®).

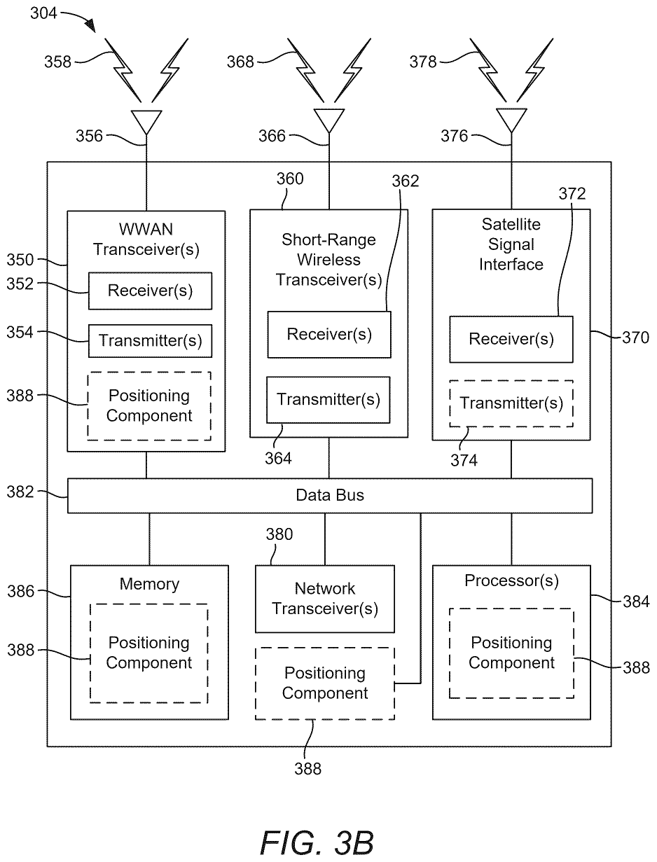

FIG. 4 is a diagram 400 illustrating an example ESL deployment scenario, according to aspects of the disclosure. Specifically, FIG. 4 illustrates a top view of a scenario where ESLs (e.g., ESLs 140) are deployed on both sides of two aisles of shelves in a retail establishment, warehouse, or the like. In the example of FIG. 4, groups of three ESLs are connected to a rail controller (e.g., a rail controller 130 utilizing, for example, a BLE radio) and the rail controllers are spaced 1 m to 2 m apart. However, as will be appreciated, this is merely an example configuration and there may be more or fewer ESLs per rail controller spaced closer or further apart.

In some cases, the ESLs may not be equipped with short-range wireless communications radios (e.g., BLE radios), and instead, the rail controller may include the short-range wireless communications radio for the three ESLs connected to it. In either case, the radio associated with an ESL (whether a component of the ESL of the rail controller to which the ESL is connected) may be referred to as an “ESL radio.” Note that, as an ESL may include a radio (see, e.g., FIG. 2), the term “ESL” may also refer to the ESL radio. Where the radio is explicitly not included in the ESL, the ESL may be referred to as an “ESL display.” Further note, however, that ESLs and ESL radios are merely examples, and the disclosure is applicable to other types of wireless radios associated with other types of electronic label devices. Such radios may be referred to as “wireless electronic label device radios,” “electronic label device radios,” “wireless electronic label radios,” “electronic label radios,” and/or the like.

Indoor positioning based on BLE beaconing from ESLs is being developed for retail and warehouse applications. In general, the location of a target device (e.g., an energy harvesting tag (eTag)) is determined based on signal strength measurements (e.g., received signal strength indicator (RSSI)) of beacon signals transmitted by multiple ESLs. Trilateration using RSSI has been observed to be highly unreliable, as the RSSI is very susceptible to attenuation, which in turn leads to poor range estimation accuracy. Instead, the weighted centroid algorithm is considered to be much more robust to attenuation and non-line-of-sight (NLOS) effects.

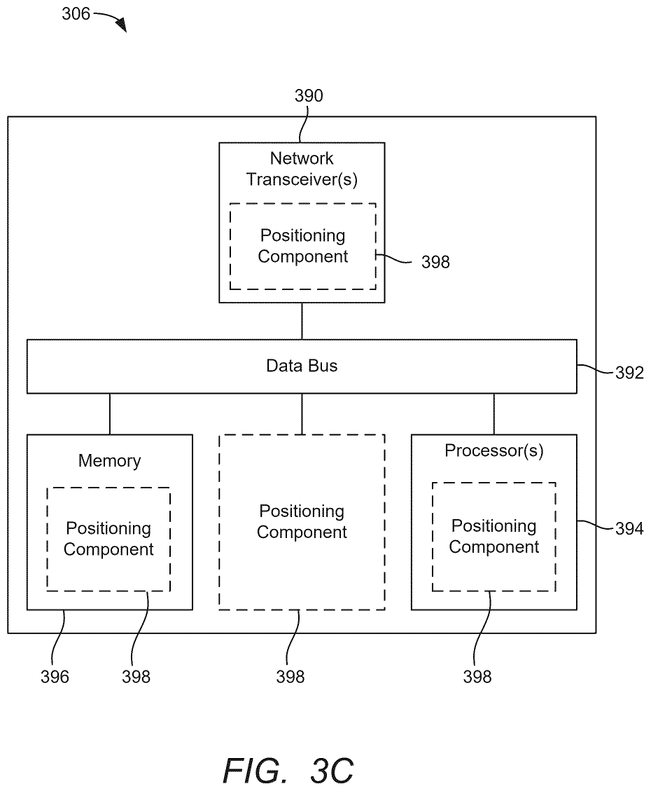

FIG. 5 is a diagram 500 illustrating an example positioning scenario using a weighted centroid algorithm, according to aspects of the disclosure. In the example of FIG. 5, measurements of the beacon signals transmitted by three ESL radios (labeled “ESL1,” “ESL2,” and “ESL3”) are used to determine a location of a target device (labeled “eTag”). For a given target device beacon transmission, let r₁≥ r₂≥ . . . r_{M} denote the RSSI values of the beacon as measured by M ESL radios (in descending order). The target device position estimate is then given by the weighted average of the ESL radio positions, where the weights are a function of the RSSI values:

$$\hat{P} = \frac{{\sum }_{k = 1}^{N} {w}_{k} \cdot {P}_{k}}{{\sum }_{k = 1}^{N} {w}_{k}}$$

In the above equations, N<M is the maximum number of ESL radios that are used in the computation, and wₖ is an exponential function (based on a value λ) of the RSSI values. N and λ are empirical terms that may be preset to some desired value. The weights may be proportional to the RSSIs. That is, the weight assigned to the k^{th} ESL radio is proportional to the signal strength measured by that ESL radio, meaning an ESL radio associated with a higher RSSI may be assigned a larger weight. In the example of FIG. 5, w₃>w₁>w₂.

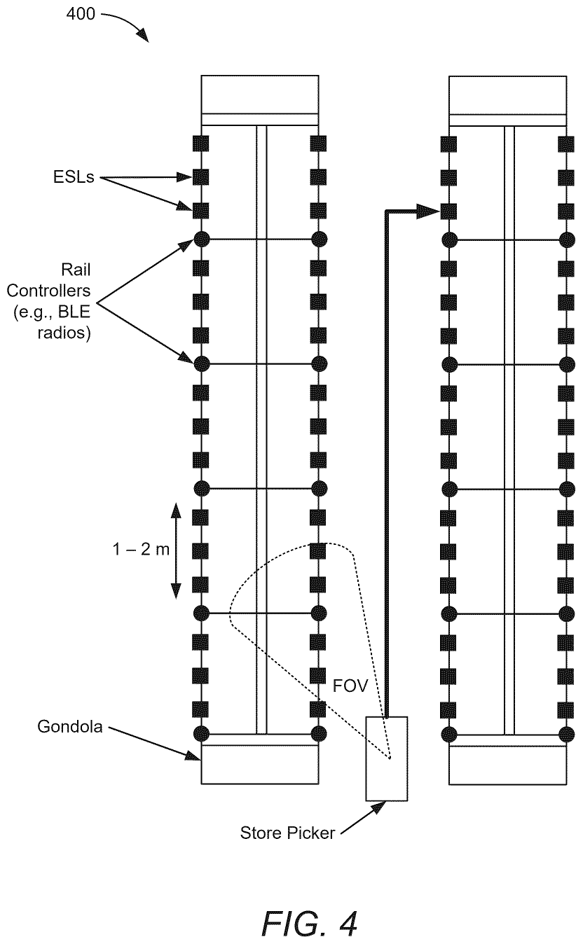

Low-cost battery-less energy harvesting “tags” (referred to as “eTags” or ambient Internet-of-Things (A-IoT) tags or simply electronic tags) are being developed that can be affixed to various types of assets for various purposes, such as positioning, tracking, verification/validation, product information storage, etc. FIG. 6 illustrates an example eTag 600, according to aspects of the disclosure. The example eTag 600 is a flexible printed circuit (FPC) having a size of, for example, 43 mm by 45 mm by 0.2 mm. In some cases, the eTag 600 may be encapsulated in a paper or plastic label with an adhesive backing that can be attached to an asset.

eTags do not include batteries, but rather, are energized by (harvest energy from) received wireless signals, similar to a radio frequency identification (RFID) tag. As such, the eTag 600 includes an energy harvesting antenna 610, which may operate in the 900 MHz range. An eTag, such as eTag 600, may be able to harvest energy from a transmitter as far away as 20 m (in contrast, an RFID tag needs to be within a few meters of the transmitter to be able to perform energy harvesting).

The energy captured by the energy harvesting antenna 610 is stored in an external capacitor 620, which in turn powers a test chip 630 and a transmit antenna 640. When powered by the external capacitor 620, the test chip 630 provides information for transmission to the transmit antenna 640. The transmit antenna 640 may operate in the 2.4 GHz range according to one or more communication protocols (e.g., BLE, Wi-Fi®, NR). For example, the test chip 630 and transmit antenna 640 may act as a BLE beacon and support BLE advertisement transmission. Note that in some cases, the transmit antenna 640 may also act as an energy harvesting antenna. In some cases, where the energy harvesting antenna 610 and the transmit antenna 640 are the same antenna, the combination of the energy harvesting antenna 610 and the transmit antenna 640 may be referred to as a transceiver.

In some cases, the eTag 600 may include one or more sensors 650. Such sensors may include temperature sensors, pressure sensors, and/or other low energy sensors.

In some cases, to position an eTag 600 using the positioning method illustrated by FIG. 5, the eTag 600 may be energized to transmit one or more BLE beacon transmissions to nearby ESL radios (e.g., ESL1, ESL2, and ESL3). The ESL radios may report their RSSI measurements to the central management entity 110, which may calculate the position of the eTag 600 or forward the measurements to another entity for processing.

An example wireless communication protocol that may be utilized to support ESL-to-AP signaling is the BLE generic attribute profile (GATT) protocol. For example, ESLs may contain a BLE GATT server, and scan result read characteristics can be defined for target device RSSI measurements (e.g., for the reporting of target RSSI measurements from ESL(s) to the ESL AP). Advantages of the BLE GATT protocol include support for bulk data read operations, allowing for accumulation and less frequent reads of target device scan results. This can be useful if there are many active target devices (e.g., battery-less energy harvesting tags (eTags)). A downside of the BLE GATT protocol is the overhead of the BLUETOOTH® asynchronous connection-oriented logical transport (ACL) connect/disconnect for every query, which results in slower response time.

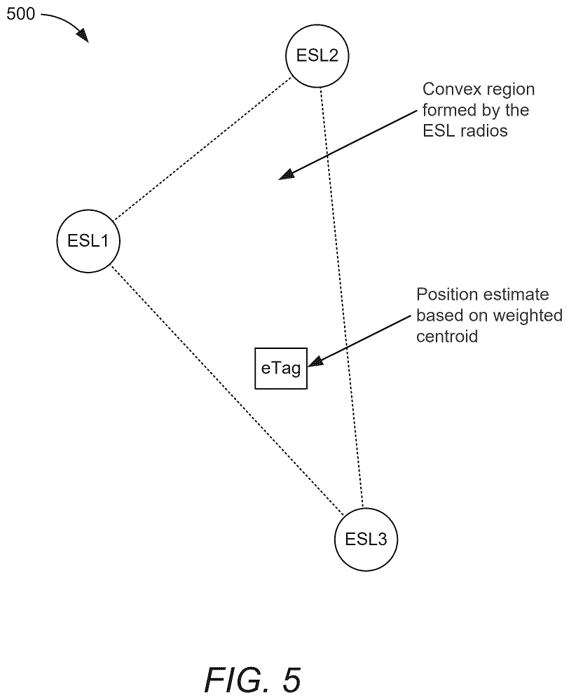

FIG. 7 illustrates an example BLE GATT procedure 700, according to aspects of the disclosure. At stage (1), a GATT client performs service discovery with a GATT server. At stage (2), the GATT client populates a table of available service(s) of the GATT server obtained from stage (1). At stage (3a), the GATT client transmits a client request to the GATT server. At stage (4a), the GATT server transmits a server response to the client request from stage (3a). As an alternative to (or in addition to) stages (3a) and (4a), at stage (3b), the GATT client may transmit a switch ON indication or notification to the GATT server, and at stage (4b), the GATT server may perform a server-initiated data transfer.

Another example wireless communications protocol that may be utilized to support ESL-to-AP signaling is the ESL periodic advertising with responses (PAWR) protocol. In ESL PAWR, ESLs can be sent a vendor-specific command via an advertising synchronization packet from the AP, and target device RSSI data can be reported by the ESL in a specific advertisement slot period. ESLs may be grouped and addressed as a group (via a group ID). An advantage to this approach is minimum overhead and quick response time. A downside to this approach is the advertisement packet payload size is limited (48 bytes), so only one target device payload (40 bytes) may fit in one slot. As such, multiple target devices' data may need multiple slots. Note that the duration of a frame may vary from as low as 1.6 seconds to as long as 16 seconds (based on configuration).

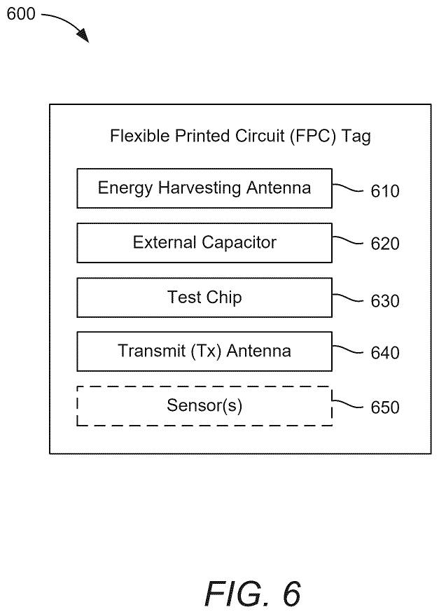

FIG. 8 illustrates an example ESL PAWR scheme 800, according to aspects of the disclosure. The ESL PAWR scheme 800 is described with respect to a cluster/group of ESLs that includes four ESLs, denoted as ESLs 1-4. At slot t0, the ESL AP transmits scheduling information to ESLs 1-4. Assuming that ESLs 1-4 operate in ESL radio scan mode (i.e., receive (Rx) mode) during slots t1-t4 (e.g., collecting ESL measurement information), then ESLs 1-4 each transmit measurement feedback collected during the ESL radio scan mode to the ESL AP during slots t5-t8. Note that each ESL 1-4 may only wake up once every frame to listen and respond. As will be appreciated, for highly populated clusters/groups of ESLs, the measurement feedback to the ESL AP can take a significant amount of time and incur high signaling and scheduling overhead.

It has been proposed to adapt the beaconing rate of an ESL radio based on its distance from a target device. This would enable a mobile device (e.g., a UE) to estimate its position for indoor navigation and product-finding use cases. For example, as discussed above with reference to FIG. 5, the mobile device can measure the RSSI of the ESL radios' beacons. However, this can result in a significant drop in ESL battery life.

In the present disclosure, the deployment of battery-less energy-harvesting tags (referred to as “eTags” or ambient-IoT (A-IoT) tags) is disclosed to enable the location estimation of a UE. In some cases, this can complement the adaptive beaconing rate technique, insofar as the ESL radios could beacon at very low rates, or not beacon altogether, thereby drastically improving their battery life.

At a high level, the present disclosure provides techniques for (1) configuring eTags deployed on the shelves or a retail store, warehouse, etc. as anchor nodes for UE positioning, (2) mitigating interference between shelf eTags, non-shelf eTags (e.g., attached to inventory or assets), and ESL radios, (3) signaling ESL radios via shelf eTag beacons to display a visual indication on an associated ESL display, and (4) inferring user statistics and behavior using an eTag deployment.

Referring to using eTags as anchor nodes for UE positioning, eTags may be deployed across the shelves, walls, or similar structures within an indoor venue. At the time of deployment, the location of each eTag may be stored along with an eTag identifier (e.g., a MAC address or other unique identifier (ID)).

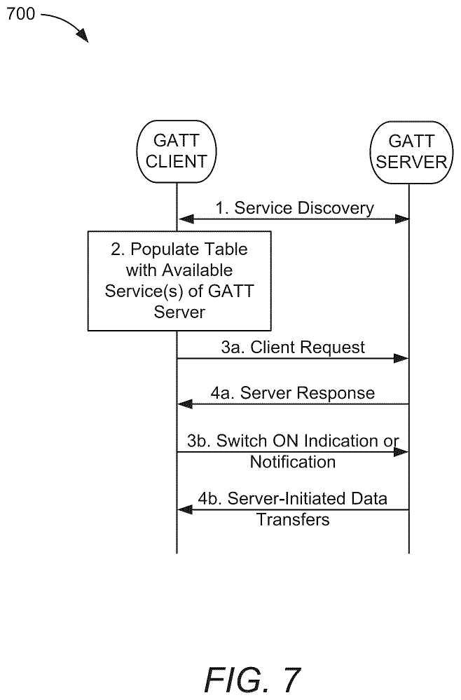

FIG. 9 is a diagram 900 illustrating an example scenario of positioning a UE using eTags as anchor nodes, according to aspects of the disclosure. To position a UE, energizing waveforms may be broadcasted and may serve two functions: (1) wireless power transfer, i.e., charging eTags, and (2) control information transfer. For the control information transfer, the wakeup signal data (WUS-D) portion of the energizing waveform may include control information that influences the transmission behavior of the eTags in the upcoming subframe (i.e., the subframe immediately following the energizing waveform).

To assist in mitigating interference between shelf eTags, non-shelf eTags, and ESL radios, each eTag may store a look-up table (LUT), which may store a mapping between a configuration ID and the associated time, frequency, and/or spatial resources. More specifically, the LUT may store a cluster size, time slot offset, and channel associated with each configuration ID. Note that in some cases, the LUT may be a permanent version that is stored at the time of fabrication or may be reprogrammable. The following table illustrates an example LUT:

TABLE 1

| Configuration ID | Cluster Size | Time Slot Offset | Channel |
|---|---|---|---|
| 1 | 1 | 0 | 37 |
| 2 | 1 | 2 | 39 |
| 3 | 5 | 1 | 37 |

The cluster size may indicate the spatial interleaving factor. For example, a cluster size of “1” implies that all eTags in a spatial area (e.g., an aisle) would transmit beacon signals, while a cluster size of “5” would imply that every fifth eTag would transmit. Note that each eTag is associated with a unique LUT, and therefore, only a matching configuration ID in the WUS-D and LUT entry would trigger a transmission from an eTag during a given subframe.

The time slot offset is an offset after which a beacon is transmitted by a cluster. For example, a first eTag's LUT may indicate a beacon transmission during the eighth slot as part of a first cluster, and a second eTag's LUT may indicate a beacon transmission during the ninth slot as part of a second cluster. In some cases, this offset value may refer to an absolute time slot index within the subframe (e.g., from 0 to 17).

The channel column of the LUT may refer to, for example, a BLE channel (or more generally a set of frequency resources) that may be used by the eTag (and other eTags that are part of the same cluster).

In some cases, the WUS-D may also contain a “shelf flag bit” that indicates to the eTags whether only shelf-located eTags may transmit during a given subframe (e.g., using a bit value of “1”) or only non-shelf-located eTags may transmit (e.g., using a bit value of “0”). More generally, a “subset ID” may be included as part of the WUS-D, where a subset may include both shelf-located eTags and non-shelf-located eTags. In this case, each eTag receiving the WUS-D may refer to its LUT to determine whether it belongs to the indicated subset ID or not.

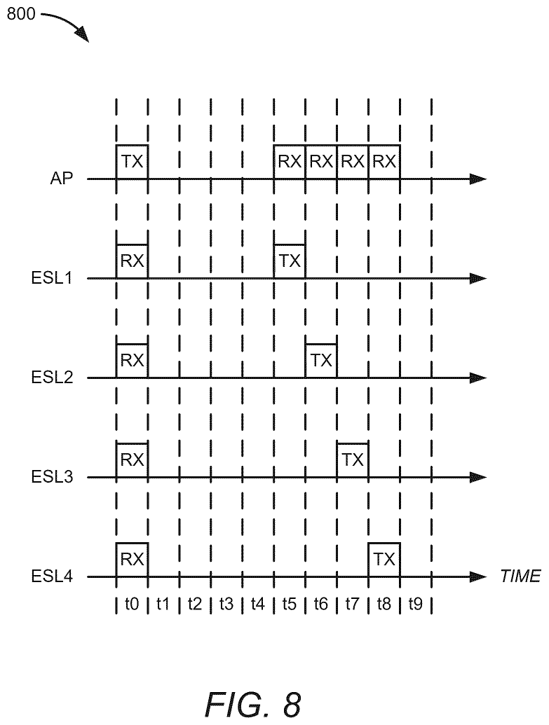

Alternatively, both types of eTags (e.g., shelf-located and non-shelf-located) may transmit during a subframe, but over non-overlapping time slots during the subframe, as illustrated in FIG. 10. In some cases, shelf eTags may use the same set of slots as those used by ESL radios to transmit response packets to the AP, as also illustrated in FIG. 10. In some cases, the server may indicate to the ESL radios (via the ESL AP) to transmit over a given channel “A,” while shelf-located eTags are scheduled to transmit over a given channel “B” that is non-overlapping with channel “A.”

FIG. 10 is a diagram 1000 illustrating examples of reserved slots within a subframe, according to aspects of the disclosure. In the example of FIG. 10, a 12.5 millisecond (ms) subframe consists of 20 slots. In the first slot of the subframe, the AP may perform transmission. Eleven slots of the same or a different subframe may be reserved for both shelf-located eTags and ESL responses to the AP transmission. Six slots of the same or a different subframe may be reserved for non-shelf-located eTags. Here, the slot length may be longer than the slot length of the slots reserved for both shelf-located eTags and ESL responses.

With continued reference to FIG. 9 and positioning a UE using eTags as anchor nodes, the shelf-located eTags transmit beacons as per the schedule indicated in the WUS-D. In the example of FIG. 9, four eTags are configured to transmit beacons in a given subframe. In the case that a shelf-located eTag has not fully energized for a beacon transmission, it will skip transmitting during the current subframe and wait for a subsequent subframe. The eTag may then follow the schedule as indicated for the upcoming/subsequent subframe.

Based on assistance data received from the server, the UE scans for eTag beacons during the scheduled subframes. The server may provide the UE with a set of time periods and frequency resources/channels to scan. The UE measures the RSSI (and/or any other positioning measurement, such as time of arrival (ToA), angle of arrival (AoA), etc.) and relays the values to the server. Each measurement is also associated with a unique eTag ID.

Upon receipt of the measurements, the server estimates the position of the UE and may provide the estimated position back to the UE. Alternatively, the server may send an indication of a navigation instruction on an application associated with the UE (e.g., to enable indoor navigation and product finding).

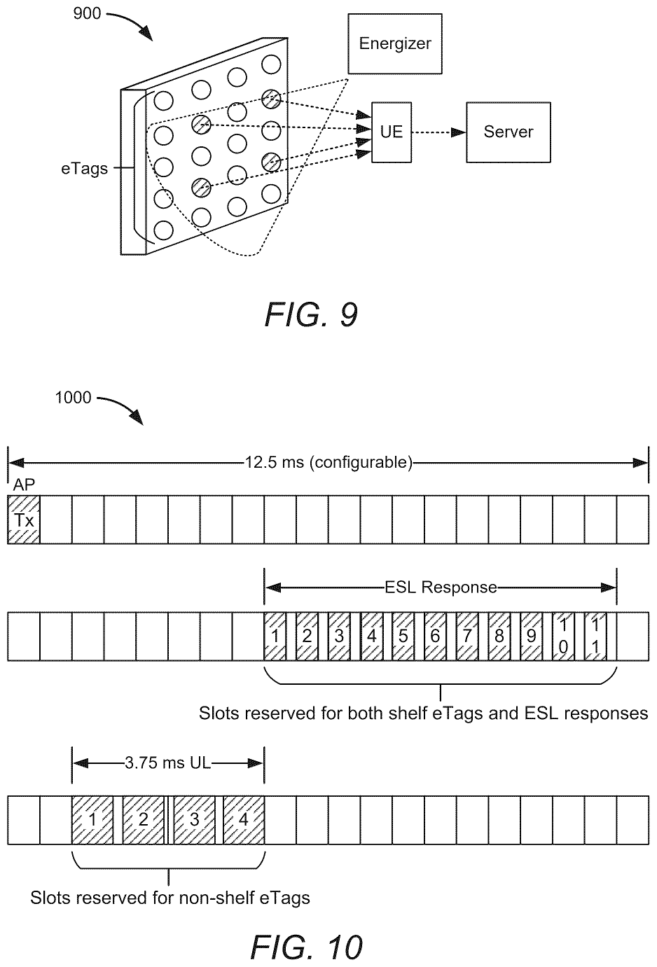

FIG. 11 illustrates an example method 1100 of positioning, according to aspects of the disclosure. In an aspect, method 1100 may be performed by an eTag (e.g., any of the eTags described herein).

At operation 1110, the eTag may receive an energizing waveform including control information (e.g., WUS-D), where the control information indicates a configuration for beacon signal transmission by the eTag, where the configuration indicates a spatial interleaving factor, a time slot offset, and a channel.

In an aspect, operation 1110 may be performed by the energy harvesting antenna 610, the external capacitor 620, the test chip 630, the transmit antenna 640, and/or the sensor(s) 650, any or all of which may be considered means for performing this operation.

At operation 1120, the eTag may transmit, during a subsequent subframe, a beacon signal according to the configuration.

In an aspect, operation 1120 may be performed by the energy harvesting antenna 610, the external capacitor 620, the test chip 630, the transmit antenna 640, and/or the sensor(s) 650, any or all of which may be considered means for performing this operation.

As will be appreciated, a technical advantage of the method 1100 is providing positioning services using low-cost energy harvesting tags (e.g., eTags), along with interleaving capability across time, frequency, and spatial dimensions.

Referring now to signaling ESLs to display visual indications, in general, visual indications for ESLs are typically triggered by an ESL AP sending a beacon packet that comprises ESL commands for displaying specific types of information. However, in the disclosure, a shelf eTag may be directly connected to the ESL sub-system. That is, a given shelf eTag, ESL display, and ESL radio are all connected to the same processor or sub-system.

In this case, control information in the WUS-D may directly indicate to the ESL sub-system (via the shelf eTag) to display a certain visual indication (e.g., certain text, flashing a light-emitting diode (LED) with a certain pattern, color, etc.). The control information may be mapped to an entry in an LUT. For example, an indication ID may be interpreted by the ESL sub-system as a certain ESL command, which in turn may be mapped to a given visual indication.

In some cases, the energizing waveform may be transmitted in a highly directional manner (i.e., small beamwidth), so as to target a specific shelf eTag associated with a certain ESL display. For example, a user dwell time may be inferred through estimation of UE location over a period of time. If the dwell time exceeds a threshold value, then a visual indication may be displayed.

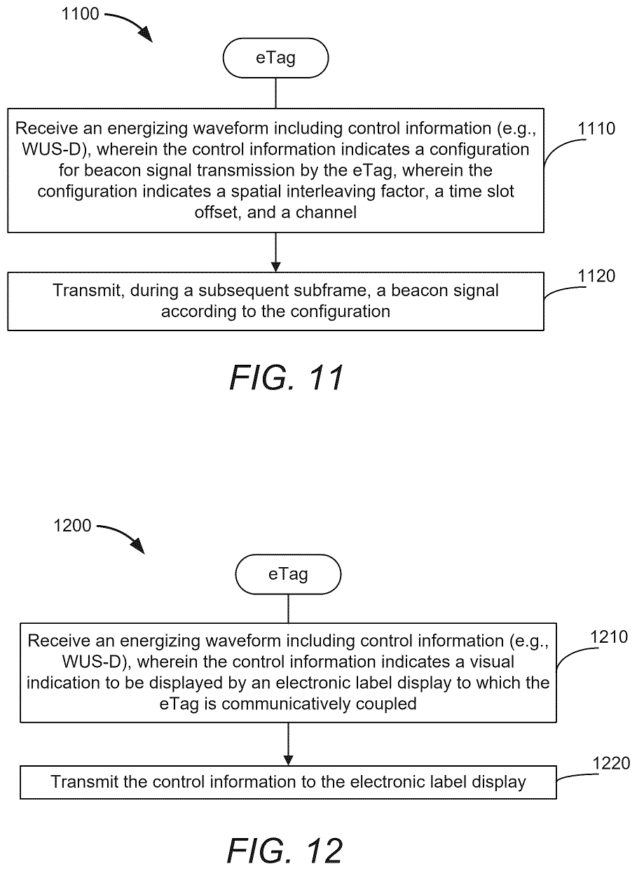

FIG. 12 illustrates an example method 1200 of communication, according to aspects of the disclosure. In an aspect, method 1200 may be performed by an eTag (e.g., any of the eTags described herein).

At operation 1210, the eTag may receive an energizing waveform including control information (e.g., WUS-D), where the control information indicates a visual indication to be displayed by an electronic label display (e.g., ESL/ESL display) to which the eTag is communicatively coupled.

In an aspect, operation 1210 may be performed by the energy harvesting antenna 610, the external capacitor 620, the test chip 630, the transmit antenna 640, and/or the sensor(s) 650, any or all of which may be considered means for performing this operation.

At operation 1220, the eTag may transmit the control information to the electronic label display.

In an aspect, operation 1220 may be performed by the energy harvesting antenna 610, the external capacitor 620, the test chip 630, the transmit antenna 640, and/or the sensor(s) 650, any or all of which may be considered means for performing this operation.

As will be appreciated, a technical advantage of the method 1200 is updating display information based on control information received through a low-cost energy harvesting tag (e.g., an eTag).

Referring now to inferring user statistics and behavior using a deployment of eTags, in addition to UE location estimation, eTags within an indoor venue can be used to infer user statistics and behavior, such as overall foot traffic, dwell times in certain parts of the venue, etc. In this case, a UE may report a timestamp value and a user profile/preferences to the server (in addition to eTag ID and RSSI). The UE may also be triggered to transmit energizing waveforms when it is detected to be approaching or within the venue.

In response, the server may update its database to reflect the number of UEs that received a beacon from a given eTag with at least a minimum RSSI value. This would indicate the overall foot traffic for an eTag deployed at the entrance to the venue. The server may also store information indicating that a UE that received a beacon from a given eTag with at least a minimum RSSI value for a threshold period of time. This would indicate that this particular user is interested in a certain segment of products, thereby enabling targeted advertising to the user.

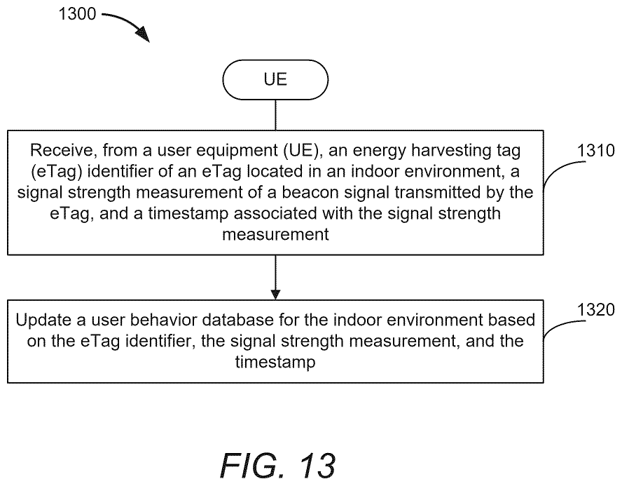

FIG. 13 illustrates an example method 1300 of communication, according to aspects of the disclosure. In an aspect, method 1300 may be performed by a server (e.g., any of the servers described herein).

At operation 1310, the server may receive, from a UE, an energy harvesting tag (eTag) identifier of an eTag located in an indoor environment, a signal strength measurement of a beacon signal transmitted by the eTag, and a timestamp associated with the signal strength measurement.

In an aspect, operation 1310 may be performed by the one or more network transceivers 390, the one or more processors 394, memory 396, and/or positioning component 398, any or all of which may be considered means for performing this operation.

At operation 1320, the server may update a user behavior database for the indoor environment based on the eTag identifier, the signal strength measurement, and the timestamp.

In an aspect, operation 1320 may be performed by the one or more network transceivers 390, the one or more processors 394, memory 396, and/or positioning component 398, any or all of which may be considered means for performing this operation.

As will be appreciated, a technical advantage of the method 1300 is inferring user behavior using a deployment of low-cost energy harvesting tags (e.g., eTags).

Note that while the foregoing has generally referred to ESLs, the techniques of the present disclosure are applicable to any type of electronic label display.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1: A method of positioning performed by an energy harvesting tag (eTag), comprising: receiving an energizing waveform including control information, wherein the control information indicates a configuration for beacon signal transmission by the eTag, wherein the configuration indicates a spatial interleaving factor, a time slot offset, and a channel; and transmitting, during a subsequent subframe, a beacon signal according to the configuration.

Clause 2: The method of clause 1, wherein: the configuration is indicated by a configuration identifier; the configuration identifier is mapped to an entry in a lookup table stored at the eTag; and the entry in the lookup table includes at least the spatial interleaving factor, the time slot offset, and the channel.

Clause 3: The method of any of clauses 1 to 2, wherein: the spatial interleaving factor indicates a cluster size of eTags; and a cluster size of N indicates that every N-th eTag is expected to transmit a beacon signal in a next-occurring subframe.

Clause 4: The method of any of clauses 1 to 3, wherein the time slot offset indicates a slot offset after which the beacon signal is to be transmitted during the subsequent subframe.

Clause 5: The method of any of clauses 1 to 4, wherein the channel is a BLUETOOTH Low Energy (BLE) channel.

Clause 6: The method of any of clauses 1 to 5, wherein the control information further indicates a shelf flag bit or a subset identifier that indicates whether only shelf eTags are permitted to transmit beacon signals during a specified subframe or only non-shelf eTags are permitted to transmit beacon signals during the specified subframe.

Clause 7: The method of any of clauses 1 to 6, wherein both shelf e-Tags and non-shelf e Tags are permitted to transmit beacon signals during a same subframe: on different slots; on different channels; or a combination thereof.

Clause 8: The method of any of clauses 1 to 7, wherein the subsequent subframe is: a next occurring subframe after reception of the energizing waveform; or a next occurring subframe after a full charge is obtained from the energizing waveform.

Clause 9: The method of any of clauses 1 to 8, wherein: the beacon signal includes an identifier of the eTag; the identifier of the eTag is mapped to a location of the eTag; and the location of the eTag and a signal strength measurement of the beacon signal are used to position a target device that obtained the signal strength measurement.

Clause 10: A method of communication performed by an energy harvesting tag (eTag), comprising: receiving an energizing waveform including control information, wherein the control information indicates a visual indication to be displayed by an electronic label display to which the eTag is communicatively coupled; and transmitting the control information to the electronic label display.

Clause 11: The method of clause 10, wherein: the control information is mapped to an entry in a lookup table stored at the electronic label display; and the entry in the lookup table indicates the visual indication.

Clause 12: The method of any of clauses 10 to 11, wherein the control information indicates the visual indication based on a dwell time of a user equipment (UE) associated with the electronic label display being greater than a threshold.

Clause 13: The method of any of clauses 10 to 12, wherein the visual indication includes: text; color; shape; pattern; update frequency; or any combination thereof.

Clause 14: A method of communication performed by a server, comprising: receiving, from a user equipment (UE), an energy harvesting tag (eTag) identifier of an eTag located in an indoor environment, a signal strength measurement of a beacon signal transmitted by the eTag, and a timestamp associated with the signal strength measurement; and updating a user behavior database for the indoor environment based on the eTag identifier, the signal strength measurement, and the timestamp.

Clause 15: The method of clause 14, wherein the user behavior database is updated to indicate a number of UEs that received beacon signals from the eTag with at least a minimum signal strength.

Clause 16: The method of any of clauses 14 to 15, wherein the eTag is deployed at an entrance of the indoor environment.

Clause 17: The method of any of clauses 14 to 16, wherein the user behavior database is updated to indicate that the UE received beacon signals, including the beacon signal, from the eTag with at least a minimum signal strength for at least a threshold period of time.

Clause 18: The method of any of clauses 14 to 17, further comprising: receiving, from the UE, one or more user preferences of a user of the UE; and updating the user behavior database based on the one or more user preferences.

Clause 19: An energy harvesting tag (eTag), comprising: one or more memories; one or more antennas; and one or more processors communicatively coupled to the one or more memories and the one or more antennas, the one or more processors, either alone or in combination, configured to: receive, via the one or more antennas, an energizing waveform including control information, wherein the control information indicates a configuration for beacon signal transmission by the eTag, wherein the configuration indicates a spatial interleaving factor, a time slot offset, and a channel; and transmit, via the one or more antennas, during a subsequent subframe, a beacon signal according to the configuration.

Clause 20: The eTag of clause 19, wherein: the configuration is indicated by a configuration identifier; the configuration identifier is mapped to an entry in a lookup table stored at the eTag; and the entry in the lookup table includes at least the spatial interleaving factor, the time slot offset, and the channel.

Clause 21: The eTag of any of clauses 19 to 20, wherein: the spatial interleaving factor indicates a cluster size of eTags; and a cluster size of N indicates that every N-th eTag is expected to transmit a beacon signal in a next-occurring subframe.

Clause 22: The eTag of any of clauses 19 to 21, wherein the time slot offset indicates a slot offset after which the beacon signal is to be transmitted during the subsequent subframe.

Clause 23: The eTag of any of clauses 19 to 22, wherein the channel is a BLUETOOTH Low Energy (BLE) channel.

Clause 24: The eTag of any of clauses 19 to 23, wherein the control information further indicates a shelf flag bit or a subset identifier that indicates whether only shelf eTags are permitted to transmit beacon signals during a specified subframe or only non-shelf eTags are permitted to transmit beacon signals during the specified subframe.

Clause 25: The eTag of any of clauses 19 to 24, wherein both shelf e-Tags and non-shelf e Tags are permitted to transmit beacon signals during a same subframe: on different slots; on different channels; or a combination thereof.

Clause 26: The eTag of any of clauses 19 to 25, wherein the subsequent subframe is: a next occurring subframe after reception of the energizing waveform; or a next occurring subframe after a full charge is obtained from the energizing waveform.

Clause 27: The eTag of any of clauses 19 to 26, wherein: the beacon signal includes an identifier of the eTag; the identifier of the eTag is mapped to a location of the eTag; and the location of the eTag and a signal strength measurement of the beacon signal are used to position a target device that obtained the signal strength measurement.

Clause 28: An energy harvesting tag (eTag), comprising: one or more memories; one or more antennas; and one or more processors communicatively coupled to the one or more memories and the one or more antennas, the one or more processors, either alone or in combination, configured to: receive, via the one or more antennas, an energizing waveform including control information, wherein the control information indicates a visual indication to be displayed by an electronic label display to which the eTag is communicatively coupled; and transmit, via the one or more antennas, the control information to the electronic label display.

Clause 29: The eTag of clause 28, wherein: the control information is mapped to an entry in a lookup table stored at the electronic label display; and the entry in the lookup table indicates the visual indication.

Clause 30: The eTag of any of clauses 28 to 29, wherein the control information indicates the visual indication based on a dwell time of a user equipment (UE) associated with the electronic label display being greater than a threshold.

Clause 31: The eTag of any of clauses 28 to 30, wherein the visual indication includes: text; color; shape; pattern; update frequency; or any combination thereof.

Clause 32: A server, comprising: one or more memories; one or more transceivers; and one or more processors communicatively coupled to the one or more memories and the one or more transceivers, the one or more processors, either alone or in combination, configured to: receive, via the one or more transceivers, from a user equipment (UE), an energy harvesting tag (eTag) identifier of an eTag located in an indoor environment, a signal strength measurement of a beacon signal transmitted by the eTag, and a timestamp associated with the signal strength measurement; and update a user behavior database for the indoor environment based on the eTag identifier, the signal strength measurement, and the timestamp.

Clause 33: The server of clause 32, wherein the user behavior database is updated to indicate a number of UEs that received beacon signals from the eTag with at least a minimum signal strength.

Clause 34: The server of any of clauses 32 to 33, wherein the eTag is deployed at an entrance of the indoor environment.

Clause 35: The server of any of clauses 32 to 34, wherein the user behavior database is updated to indicate that the UE received beacon signals, including the beacon signal, from the eTag with at least a minimum signal strength for at least a threshold period of time.

Clause 36: The server of any of clauses 32 to 35, wherein the one or more processors, either alone or in combination, are further configured to: receive, via the one or more transceivers, from the UE, one or more user preferences of a user of the UE; and update the user behavior database based on the one or more user preferences.

Clause 37: An energy harvesting tag (eTag), comprising: means for receiving an energizing waveform including control information, wherein the control information indicates a configuration for beacon signal transmission by the eTag, wherein the configuration indicates a spatial interleaving factor, a time slot offset, and a channel; and means for transmitting, during a subsequent subframe, a beacon signal according to the configuration.

Clause 38: The eTag of clause 37, wherein: the configuration is indicated by a configuration identifier the configuration identifier is mapped to an entry in a lookup table stored at the eTag; and the entry in the lookup table includes at least the spatial interleaving factor, the time slot offset, and the channel.

Clause 39: The eTag of any of clauses 37 to 38, wherein: the spatial interleaving factor indicates a cluster size of eTags; and a cluster size of N indicates that every N-th eTag is expected to transmit a beacon signal in a next-occurring subframe.

Clause 40: The eTag of any of clauses 37 to 39, wherein the time slot offset indicates a slot offset after which the beacon signal is to be transmitted during the subsequent subframe.

Clause 41: The eTag of any of clauses 37 to 40, wherein the channel is a BLUETOOTH Low Energy (BLE) channel.

Clause 42: The eTag of any of clauses 37 to 41, wherein the control information further indicates a shelf flag bit or a subset identifier that indicates whether only shelf eTags are permitted to transmit beacon signals during a specified subframe or only non-shelf eTags are permitted to transmit beacon signals during the specified subframe.

Clause 43: The eTag of any of clauses 37 to 42, wherein both shelf e-Tags and non-shelf eTags are permitted to transmit beacon signals during a same subframe: on different slots; on different channels; or a combination thereof.

Clause 44: The eTag of any of clauses 37 to 43, wherein the subsequent subframe is: a next occurring subframe after reception of the energizing waveform; or a next occurring subframe after a full charge is obtained from the energizing waveform.

Clause 45: The eTag of any of clauses 37 to 44, wherein: the beacon signal includes an identifier of the eTag the identifier of the eTag is mapped to a location of the eTag; and the location of the eTag and a signal strength measurement of the beacon signal are used to position a target device that obtained the signal strength measurement.

Clause 46: An energy harvesting tag (eTag), comprising: means for receiving an energizing waveform including control information, wherein the control information indicates a visual indication to be displayed by an electronic label display to which the eTag is communicatively coupled; and means for transmitting the control information to the electronic label display.

Clause 47: The eTag of clause 46, wherein: the control information is mapped to an entry in a lookup table stored at the electronic label display; and the entry in the lookup table indicates the visual indication.

Clause 48: The eTag of any of clauses 46 to 47, wherein the control information indicates the visual indication based on a dwell time of a user equipment (UE) associated with the electronic label display being greater than a threshold.

Clause 49: The eTag of any of clauses 46 to 48, wherein the visual indication includes: text; color; shape; pattern; update frequency; or any combination thereof.

Clause 50: A server, comprising: means for receiving, from a user equipment (UE), an energy harvesting tag (eTag) identifier of an eTag located in an indoor environment, a signal strength measurement of a beacon signal transmitted by the eTag, and a timestamp associated with the signal strength measurement; and means for updating a user behavior database for the indoor environment based on the eTag identifier, the signal strength measurement, and the timestamp.

Clause 51: The server of clause 50, wherein the user behavior database is updated to indicate a number of UEs that received beacon signals from the eTag with at least a minimum signal strength.

Clause 52: The server of any of clauses 50 to 51, wherein the eTag is deployed at an entrance of the indoor environment.

Clause 53: The server of any of clauses 50 to 52, wherein the user behavior database is updated to indicate that the UE received beacon signals, including the beacon signal, from the eTag with at least a minimum signal strength for at least a threshold period of time.

Clause 54: The server of any of clauses 50 to 53, further comprising: means for receiving, from the UE, one or more user preferences of a user of the UE; and means for updating the user behavior database based on the one or more user preferences.

Clause 55: A non-transitory computer-readable medium storing computer-executable instructions that, when executed by an energy harvesting tag (eTag), cause the eTag to: receive an energizing waveform including control information, wherein the control information indicates a configuration for beacon signal transmission by the eTag, wherein the configuration indicates a spatial interleaving factor, a time slot offset, and a channel; and transmit, during a subsequent subframe, a beacon signal according to the configuration.

Clause 56: The non-transitory computer-readable medium of clause 55, wherein: the configuration is indicated by a configuration identifier; the configuration identifier is mapped to an entry in a lookup table stored at the eTag; and the entry in the lookup table includes at least the spatial interleaving factor, the time slot offset, and the channel.

Clause 57: The non-transitory computer-readable medium of any of clauses 55 to 56, wherein: the spatial interleaving factor indicates a cluster size of eTags; and a cluster size of N indicates that every N-th eTag is expected to transmit a beacon signal in a next-occurring subframe.

Clause 58: The non-transitory computer-readable medium of any of clauses 55 to 57, wherein the time slot offset indicates a slot offset after which the beacon signal is to be transmitted during the subsequent subframe.

Clause 59: The non-transitory computer-readable medium of any of clauses 55 to 58, wherein the channel is a BLUETOOTH Low Energy (BLE) channel.

Clause 60: The non-transitory computer-readable medium of any of clauses 55 to 59, wherein the control information further indicates a shelf flag bit or a subset identifier that indicates whether only shelf eTags are permitted to transmit beacon signals during a specified subframe or only non-shelf eTags are permitted to transmit beacon signals during the specified subframe.

Clause 61: The non-transitory computer-readable medium of any of clauses 55 to 60, wherein both shelf e-Tags and non-shelf eTags are permitted to transmit beacon signals during a same subframe: on different slots; on different channels; or a combination thereof.

Clause 62: The non-transitory computer-readable medium of any of clauses 55 to 61, wherein the subsequent subframe is: a next occurring subframe after reception of the energizing waveform; or a next occurring subframe after a full charge is obtained from the energizing waveform.

Clause 63: The non-transitory computer-readable medium of any of clauses 55 to 62, wherein: the beacon signal includes an identifier of the eTag; the identifier of the eTag is mapped to a location of the eTag; and the location of the eTag and a signal strength measurement of the beacon signal are used to position a target device that obtained the signal strength measurement.

Clause 64: A non-transitory computer-readable medium storing computer-executable instructions that, when executed by an energy harvesting tag (eTag), cause the eTag to: receive an energizing waveform including control information, wherein the control information indicates a visual indication to be displayed by an electronic label display to which the eTag is communicatively coupled; and transmit the control information to the electronic label display.

Clause 65: The non-transitory computer-readable medium of clause 64, wherein the control information is mapped to an entry in a lookup table stored at the electronic label display; and the entry in the lookup table indicates the visual indication.

Clause 66: The non-transitory computer-readable medium of any of clauses 64 to 65, wherein the control information indicates the visual indication based on a dwell time of a user equipment (UE) associated with the electronic label display being greater than a threshold.

Clause 67: The non-transitory computer-readable medium of any of clauses 64 to 66, wherein the visual indication includes: text; color; shape; pattern; update frequency; or any combination thereof.

Clause 68: A non-transitory computer-readable medium storing computer-executable instructions that, when executed by a server, cause the server to: receive, from a user equipment (UE), an energy harvesting tag (eTag) identifier of an eTag located in an indoor environment, a signal strength measurement of a beacon signal transmitted by the eTag, and a timestamp associated with the signal strength measurement; and update a user behavior database for the indoor environment based on the eTag identifier, the signal strength measurement, and the timestamp.

Clause 69: The non-transitory computer-readable medium of clause 68, wherein the user behavior database is updated to indicate a number of UEs that received beacon signals from the eTag with at least a minimum signal strength.

Clause 70: The non-transitory computer-readable medium of any of clauses 68 to 69, wherein the eTag is deployed at an entrance of the indoor environment.

Clause 71: The non-transitory computer-readable medium of any of clauses 68 to 70, wherein the user behavior database is updated to indicate that the UE received beacon signals, including the beacon signal, from the eTag with at least a minimum signal strength for at least a threshold period of time.

Clause 72: The non-transitory computer-readable medium of any of clauses 68 to 71, further comprising computer-executable instructions that, when executed by the server, cause the server to: receive, from the UE, one or more user preferences of a user of the UE; and update the user behavior database based on the one or more user preferences.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. An energy harvesting tag (eTag), comprising:
one or more memories;
one or more antennas; and
one or more processors communicatively coupled to the one or more memories and the one or more antennas, the one or more processors, either alone or in combination, configured to:
receive, via the one or more antennas, an energizing waveform including control information, wherein the control information indicates a configuration for beacon signal transmission by the eTag, wherein the configuration indicates a spatial interleaving factor, a time slot offset, and a channel; and
transmit, via the one or more antennas, during a subsequent subframe, a beacon signal according to the configuration.

2. The eTag of claim 1, wherein:
the configuration is indicated by a configuration identifier;
the configuration identifier is mapped to an entry in a lookup table stored at the eTag; and
the entry in the lookup table includes at least the spatial interleaving factor, the time slot offset, and the channel.

3. The eTag of claim 1, wherein:
the spatial interleaving factor indicates a cluster size of eTags; and
a cluster size of N indicates that every N-th eTag is expected to transmit a beacon signal in a next-occurring subframe.

4. The eTag of claim 1, wherein the time slot offset indicates a slot offset after which the beacon signal is to be transmitted during the subsequent subframe.

5. The eTag of claim 1, wherein the channel is a BLUETOOTH Low Energy (BLE) channel.

6. The eTag of claim 1, wherein the control information further indicates a shelf flag bit or a subset identifier that indicates whether only shelf eTags are permitted to transmit beacon signals during a specified subframe or only non-shelf eTags are permitted to transmit beacon signals during the specified subframe.

7. The eTag of claim 1, wherein both shelf e-Tags and non-shelf eTags are permitted to transmit beacon signals during a same subframe:
on different slots;
on different channels; or
a combination thereof.

8. The eTag of claim 1, wherein the subsequent subframe is:
a next occurring subframe after reception of the energizing waveform; or
a next occurring subframe after a full charge is obtained from the energizing waveform.

9. The eTag of claim 1, wherein:
the beacon signal includes an identifier of the eTag;
the identifier of the eTag is mapped to a location of the eTag; and
the location of the eTag and a signal strength measurement of the beacon signal are used to position a target device that obtained the signal strength measurement.

10. An energy harvesting tag (eTag), comprising:
one or more memories;
one or more antennas; and
one or more processors communicatively coupled to the one or more memories and the one or more antennas, the one or more processors, either alone or in combination, configured to:
receive, via the one or more antennas, an energizing waveform including control information, wherein the control information indicates a visual indication to be displayed by an electronic label display to which the eTag is communicatively coupled; and
transmit, via the one or more antennas, the control information to the electronic label display.

11. The eTag of claim 10, wherein:
the control information is mapped to an entry in a lookup table stored at the electronic label display; and
the entry in the lookup table indicates the visual indication.

12. The eTag of claim 10, wherein the control information indicates the visual indication based on a dwell time of a user equipment (UE) associated with the electronic label display being greater than a threshold.

13. The eTag of claim 10, wherein the visual indication includes:
text;
color;
shape;
pattern;
update frequency; or
any combination thereof.

14. A server, comprising:
one or more memories;
one or more transceivers; and
one or more processors communicatively coupled to the one or more memories and the one or more transceivers, the one or more processors, either alone or in combination, configured to:
receive, via the one or more transceivers, from a user equipment (UE), an energy harvesting tag (eTag) identifier of an eTag located in an indoor environment, a signal strength measurement of a beacon signal transmitted by the eTag, and a timestamp associated with the signal strength measurement; and
update a user behavior database for the indoor environment based on the eTag identifier, the signal strength measurement, and the timestamp.

15. The server of claim 14, wherein the user behavior database is updated to indicate a number of UEs that received beacon signals from the eTag with at least a minimum signal strength.

16. The server of claim 14, wherein the eTag is deployed at an entrance of the indoor environment.

17. The server of claim 14, wherein the user behavior database is updated to indicate that the UE received beacon signals, including the beacon signal, from the eTag with at least a minimum signal strength for at least a threshold period of time.

18. The server of claim 14, wherein the one or more processors, either alone or in combination, are further configured to:
receive, via the one or more transceivers, from the UE, one or more user preferences of a user of the UE; and
update the user behavior database based on the one or more user preferences.
